(19) United States
(12) Patent Application Publication
(10) Pub. No.: US 2014/0307476 A1
(43) Pub. Date: Oct. 16, 2014

(54) MULTILAYER LICENSE PLATE LIGHTING APPARATUS

(71) Applicant: GM GLOBAL TECHNOLOGY OPERATIONS LLC, Detroit, MI (US)

(72) Inventor: Jeffrey Jose' Calderas, Royal Oak, MI (US)

(73) Assignee: GM GLOBAL TECHNOLOGY OPERATIONS LLC, Detroit, MI (US)

(21) Appl. No.: 13/861,760

(22) Filed: Apr. 12, 2013

(51) Int. Cl. F21V 8/00

(52) U.S. Cl. CPC G02B 6/0076
USPC 362/616

(57) ABSTRACT

A lighting apparatus for illuminating a license plate includes a light source and a multilayer light guide. The multilayer light guide is configured to carry light from the light source and to cast light onto the license plate. The multilayer light guide includes a first layer having an exterior surface opposite the location of the license plate. A second layer is disposed between the first layer and the location of the license plate and directly abuts the light source. A third layer is disposed between the second layer and the location of the license plate. The second layer has greater index of refraction than at least one of the first layer and the third layer. In some configurations, the layer carrying light, which may be referred to as the light guide, may be formed from a multilayer optical film.

### TECHNICAL FIELD

This disclosure relates to lighting or illumination of license plates or registration plates.

### BACKGROUND

Automobiles and other vehicles carry license plates, registration plates, or other registration identifiers. Many governments require the license plate to be attached to the rear of the vehicle, the front of the vehicle, or both. Additionally, private entities may use plates to assist in identifying vehicular equipment, such as in manufacturing or assembly facilities.

### SUMMARY

A lighting apparatus for illuminating a license plate is provided. The lighting apparatus includes a light source and a multilayer light guide. The multilayer light guide is configured to carry light from the light source and to cast light onto the license plate.

The multilayer light guide includes a first layer having an exterior surface opposite the license plate. A second layer is disposed between the first layer and the license plate and directly abuts the light source. A third layer is disposed between the second layer and the license plate. The second layer has greater index of refraction than at least one of the first layer and the third layer. In some configurations, the layer carrying light, which may be referred to as the light guide, may be formed from a multilayer optical film.

The above features and advantages, and other features and advantages, of the present invention are readily apparent from the following detailed description of some of the best modes and other embodiments for carrying out the invention, which is defined solely by the appended claims, when taken in connection with the accompanying drawings.

### BRIEF DESCRIPTION OF THE DRAWINGS

FIG. 1 is a schematic elevation view of a rear portion of a vehicle having a license plate illuminated by a lighting apparatus;

FIG. 2 is a schematic plane-intersection view of the lighting apparatus taken along a line 2-2 of FIG. 1;

FIG. 3 is a schematic plane-intersection view of another lighting apparatus having an integrated appliqué and light guide, taken from a viewpoint similar to the line 2-2 of FIG. 1;

FIG. 4 is a schematic plane-intersection view of another lighting apparatus having a mid-mounted Light source, taken from a viewpoint similar to the line 2-2 of FIG. 1;

FIG. 5 is a schematic isometric view of a rear bumper portion of a vehicle having a license plate illuminated by a lighting apparatus;

FIG. 6 is a schematic cross-sectional view of the lighting apparatus taken along a line 6-6 of FIG. 5;

FIG. 7 is a schematic plane-intersection view of another lighting apparatus having a backlit emblem, taken along a line 7-7 of FIG. 1, which is similar to the line 2-2 but closer to a centerline of the vehicle;

FIG. 8A is a schematic plane-intersection view of a lighting apparatus having a multilayer light guide, taken along a line similar to the line 2-2 of FIG. 1;

FIG. 8B is a schematic plane-intersection view of the multilayer light guide of FIG. 8A having an air layer toward an interior side of the lighting apparatus;

FIG. 8C is a schematic plane-intersection view of the multilayer light guide of FIG. 8A having an air layer toward an exterior side of the lighting apparatus; and

FIG. 9 is a schematic plane-intersection view of a lighting apparatus having a multilayer light guide formed from a multilayer optical film, taken along a line similar to the line 2-2 of FIG. 1.

### DETAILED DESCRIPTION

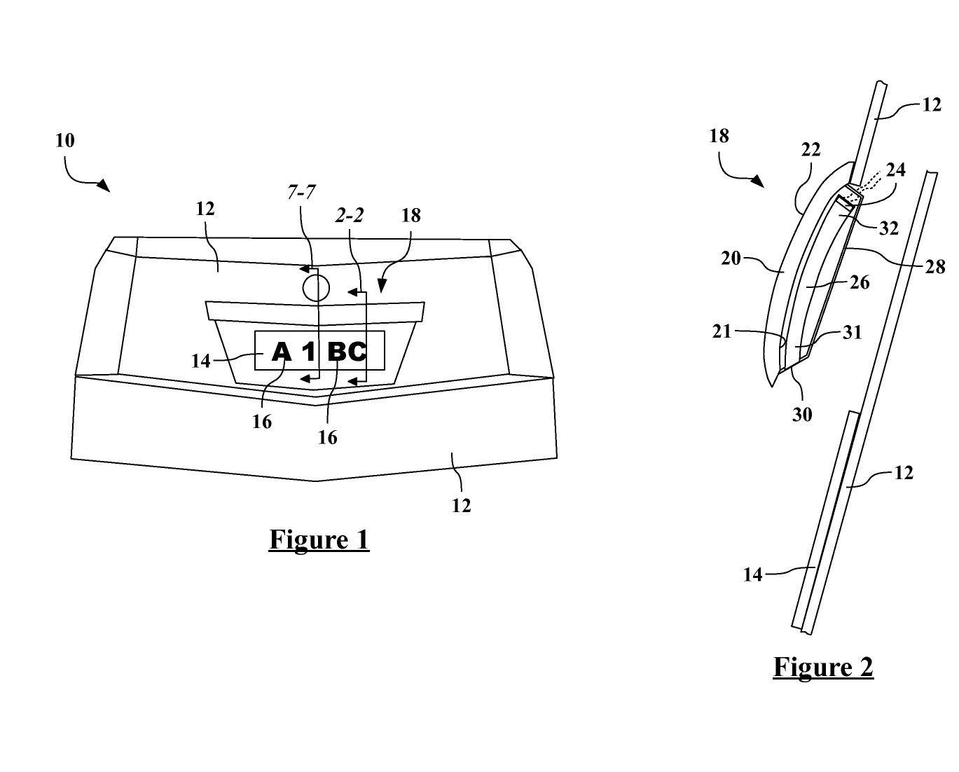

Referring to the drawings, wherein like reference numbers correspond to like or similar components wherever possible throughout the several figures, there is shown in FIG. 1 a vehicle 10. FIG. 1 shows only a rear portion of the vehicle 10, and the type of vehicle shown is illustrative only.

While the present invention may be described with respect to automotive applications, those skilled in the art will recognize the broader applicability of the invention. Those having ordinary skill in the art will recognize that terms such as “above,” “below,” “upward,” “downward,” et cetera, are used descriptively of the figures, and do not represent limitations on the scope of the invention, as defined by the appended claims. Any numerical designations, such as “first” or “second” are illustrative only and are not intended to limit the scope of the invention in any way.

The rear of the vehicle 10 includes a deck lid 12, which may commonly be referred to as a trunk or trunk lid. A license plate 14 is operatively attached to, or disposed on, the deck lid 12, such that it may generally be viewed from behind the vehicle 10. As used herein, the deck lid 12 may also incorporate portions of the rear bumper or rear fascia, and refers generally to portions of the vehicle 10 to which the license plate 14 may be attached. While the license plate 14 is shown on the rear of the vehicle 10 in FIG. 1, the license plate 14 may also be disposed on the front portion of the vehicle 14. The license plate 14 includes characters 16, which may include, without limitation, one or more numbers, letters, symbols, or combinations thereof

A lighting apparatus 18 is located above the license plate 14 and is also operatively attached to the deck lid 12. The lighting apparatus 18 illuminates the license plate 14, as may be required to facilitate reading the characters 16. Note that the lighting apparatus 18 may be similarly mounted in a bumper (not shown) of the vehicle 10 above or below the license plate 14.

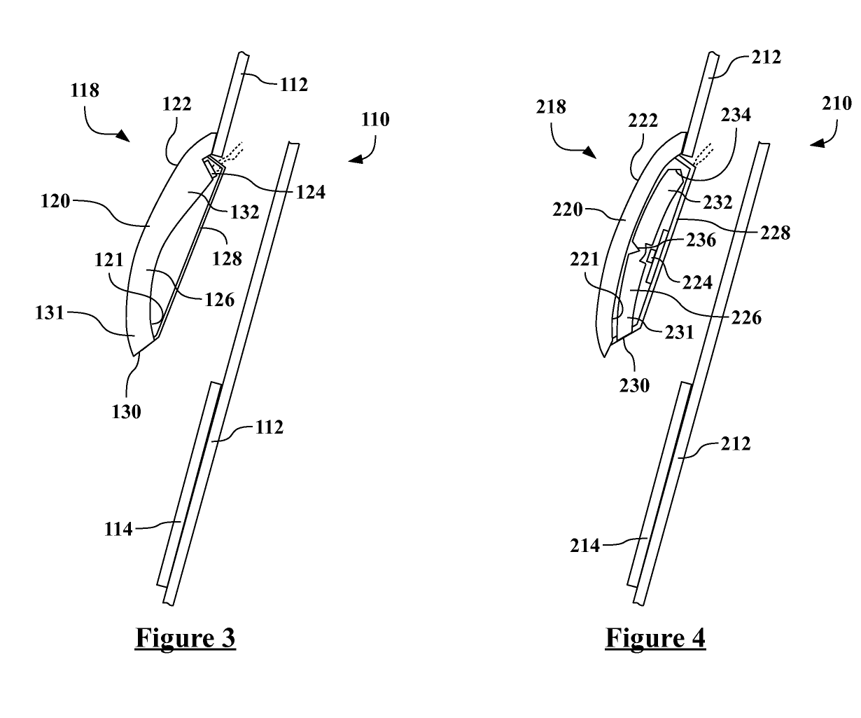

Referring now to FIG. 2, and with continued reference to FIG. 1, there is shown another view of portions of the vehicle 10 and the lighting apparatus 18. The view shown in FIG. 2 is a schematic, plane-intersection view taken approximately along a line 2-2 of FIG. 1. The plane-intersection view illustrates the edges of components intersecting the view plane but generally does not show objects in the background, as may be shown in cross-sectional views.

Note that the line 2-2 shown is somewhat offset from the centerline of the vehicle 10. However, the schematic view shown in FIG. 2 (and others) may also be illustrative of section lines taken at the centerline of the vehicle 10, such as a line 7-7, depending upon the configuration of the lighting apparatus 18.

The lighting apparatus 18 includes an appliqué 20. An interior surface 21 of the appliqué 20 faces toward the license plate 14. In the schematic view of FIG. 2, the license plate 14 may not be shown to scale, and the license plate may be much longer (vertically, as viewed in the figures) than shown.

An exterior surface 22 of the appliqué 20 faces away from the license plate 14, and is either substantially opaque or is substantially covered with an opaque coating. The opaque exterior surface 22 may be covered by, without limitation, chrome plating, paint, or other decorative or protective metallic coatings. For example, the appliqué 20 may be formed from clear or colored ABS plastic and either chrome-plated or painted to match the body color of the vehicle 10 or as an accent color. Alternatively, the appliqué 20 may be formed from an opaque material, such as opaque plastic or metal, and the opaque material may also be painted or coating.

A light source 24 acts as the light source for the lighting apparatus 18, The light source 24 may be, without limitation, a light-emitting diode (LED) element, an incandescent bulb, a compact fluorescent element, a fluorescent element, or other suitable light-generating element. In many applications, the light source 24 will be a plurality of LED elements or LED lights. A light guide 26 is disposed between the exterior surface 22 of the appliqué 20 and the license plate 14. In the configuration shown, a housing plate 28 is disposed between the interior surface 21 of the appliqué 20 and the license plate 14. The housing plate 28 may also be substantially opaque, translucent, or transparent.

The light guide 26 carries light from the light source 24 and casts it onto the license plate 14. A first optic 30 is formed on a first end 31 of the light guide 26. The light guide 26 has a second end 32 substantially opposite the first end 31. In the configuration shown in FIG. 2, the light source 24 is at the second end 32, such that the light source 24 is either adjacent to, or embedded within, the second end 32. In the configuration shown, the light guide 26 carries light from the light source 24 to the first optic 30 substantially via total internal reflection.

The first optic 30 casts light or a light pattern onto the license plate 14, such that the license plate 14 is illuminated by the lighting apparatus 18. The light pattern cast by the first optic 30 and the light guide 26 may be a single, large region substantially covering the whole of the license plate 14. Alternatively, the light pattern may consist of multiple regions and distributions of light intensity that, in combination, illuminate the characters 16.

The first optic 30 may be a simple projection surface or lens that is at a sufficient angle to prevent total internal reflection and cause light from the light source 24 to escape the light guide 26 and be cast or projected onto the license plate 14. There may be additional optical features along the length of the light guide 26 between the light source 24 and the first optic 30. For example, the light guide 26 surfaces may have optical elements or texture along their lengths to aid in directing light through the light guide 26 to the first optic 30 at the first end 31 of the light guide 26.

The appliqué 20 shown is attached to the deck lid 12. However, the appliqué 20 may also be a portion of the deck lid 12 that houses the light guide 26 and provides the light-blocking function of the opaque exterior surface 22.

Referring now to FIG. 3, and with continued reference to FIGS. 1-2, there is shown a portion of another vehicle 110 having a deck lid 112 with a license plate 114 attached thereto. A lighting apparatus 118 illuminates the license plate 114. FIG. 3 shows a plane-intersection view taken from a similar viewpoint to the line 2-2 from FIG. 1, and the lighting apparatus 118 shown in FIG. 3 may also be used with the vehicle 10 of FIG. 1.

Features shown in one figure may be combined with, substituted for, or modified by, features shown in any of the figures. Unless stated otherwise, no features, elements, or limitations are mutually exclusive of any other features, elements, or limitations. Any specific configurations shown in the figures are illustrative only and the specific configurations shown are not limiting of the claims or the description.

The lighting apparatus 118 includes an appliqué 120 having an exterior surface 122 that faces away from the license plate 114 and, an interior surface 121 that faces toward the license plate 114. The exterior surface 122 is substantially covered with an opaque coating, which may be, without limitation, chrome plating or paint.

A light source 124 acts as the light source for the lighting apparatus 118, and a light guide 126 carries light from the light source 124 and casts it onto the license plate 114. In the lighting apparatus 118, the appliqué 120 and the light guide 126 are integrated into a one-piece, unitary element. The appliqué 120 may be formed from, for example, clear ABS plastic and either chrome-plated or painted to match the body color of the vehicle 110 or as an accent color.

In the configuration shown, a housing plate 128 is disposed between the interior surface 121 of the appliqué 120 and the license plate 114. The housing plate 128 may be substantially opaque, translucent, or clear.

A first optic 130 is formed on a first end 131 of the light guide 126. The light guide 126 has a second end 132 substantially opposite the first end 131. In the configuration shown in FIG. 3, the light source 124 abuts, or is embedded within, the second end 132. The light guide 126 carries light from the light source 124 to the first optic 130, which distributes the light to the license plate 114.

In some configurations, the light guide 126 may be coated with materials on one or more sides that have a lower index of refraction than the light guide 126. These low-refraction coatings would allow for more efficient conduction of the light from the light source 124 to the first optic 130 substantially via total internal reflection.

Because the appliqué 120 and the light guide 126 are integrated into a one-piece, unitary element, the first end 131 of the light guide 126 is also the first end 131 of the appliqué 120 and the exterior surface 122 of the appliqué 120 is also the exterior surface 122 of the light guide 126. Alternatively, instead of the housing plate 128, the interior surface of the light guide 126 may be covered in a substantially-opaque coating. However, coatings may reduce the amount of light reflected by the surfaces and may absorb some of the light which may limit the amount of light passed through the light guide 126.

The lighting assembly 118, with the appliqué 120 and the light guide 126 integrated into one piece, may be attached to the deck lid 112 as a single unit. Furthermore, the combined width of the appliqué 120 and the light guide 126 may be less than that shown in FIG. 2, and the total distance of the lighting apparatus 118 from the deck lid 112 and the license plate 114 may be reduced.

The light source 124 may be a single LED that produces sufficient light for the whole license plate 114. However, the light source 124 may include a plurality of individual LED's, which are distributed across the second end 132 of the light guide 126. Numerous patterns and arrangements of individual LED's may be used for the light source 124.

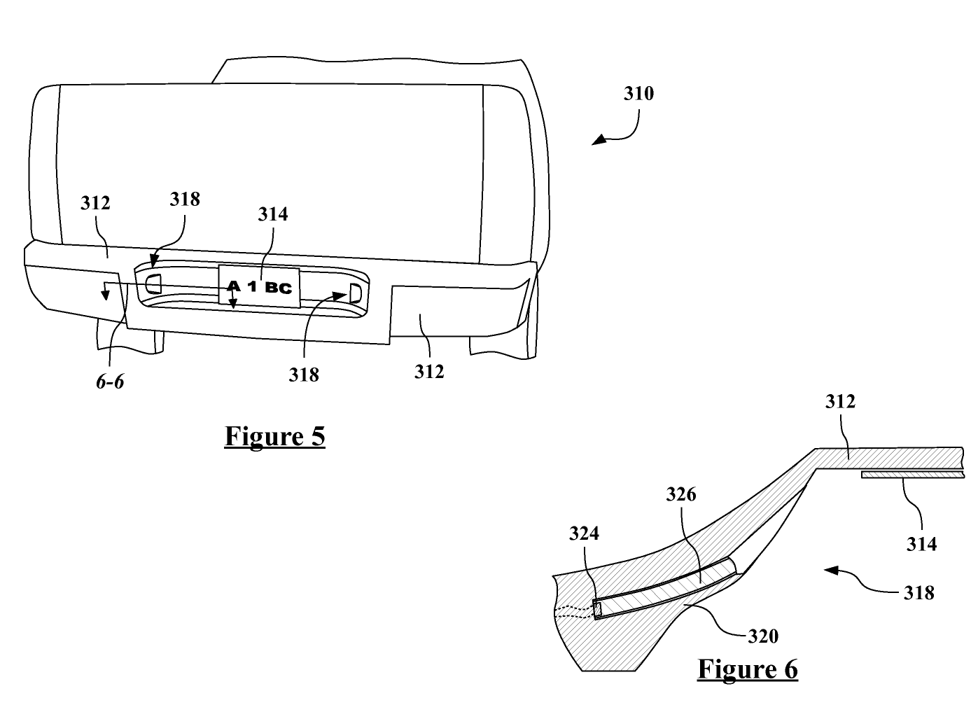

Referring now to FIG. 4, and with continued reference to FIGS. 1-3, there is shown a portion of another vehicle 210 having a deck lid 212 with a license plate 214 attached thereto. A lighting apparatus 218 illuminates the license plate 214. FIG. 4 shows a plane-intersection view taken from a similar viewpoint to the line 2-2 from FIG. 1, and the lighting apparatus 218 shown in FIG. 4 may also be used with the vehicle 10 of FIG. 1.

The lighting apparatus 218 includes an appliqué 220 having an interior surface 221 that faces toward the license plate 214 and an exterior surface 222 that faces away from the license plate 214. The exterior surface 222 is substantially covered with an opaque coating, which may be, without limitation, chrome plating or paint.

A light source 224 acts as the light source for the lighting apparatus 218, and a light guide 226 carries light from the light source 224 and casts it onto the license plate 214. In the configuration shown, a housing plate 228 is disposed between the interior surface 221 of the appliqué 220 and the license plate 214. The housing plate 228 may be substantially opaque, translucent, clear, or transparent.

The lighting apparatus 18 shown in FIG. 2 and the lighting apparatus 118 shown in FIG. 3 included end-mounted Light sources 24 and 124, respectively. However, the light source 224 of the lighting apparatus 218 is mid-mounted on the light guide 226, such that the light source 224 is disposed along the interior surface 221. The light source 224 may be adjacent to or embedded within the interior surface 221 of the light guide 226 between the first end 231 and the second end 232.

A first optic 230 is formed on a first end 231 of the light guide 226. The light guide 226 has a second end 232 substantially opposite the first end 231. The second end 232 includes a second optic 234 that redirects or reflects light toward the first optic 230.

The light guide 226 further includes a third optic 236, which is adjacent the light source 224. The third optic 236 directs light from the light source 224 toward both the first end 231 and the second end 232.

The light guide 226 may carry light from the light source 224 to the first optic 230 substantially via total internal reflection. As shown in FIG. 4, the second optic 234 may be triangular to promote total internal reflection and redirect light downward (as viewed in the figure) toward the license plate 214. Alternatively, the second optic 234 or the third optic 236 may include reflective coatings.

The light source 224 shown emits light from its face. However, the lighting apparatus 218 may alternatively have a side-emitting Light source, which emits light toward both the first end 231 and the second end 232. In configurations with the side-emitting Light source, the third optic 236 may not be necessary.

Referring now to FIG. 5 and FIG. 6, and with continued reference to FIGS. 1-4, there are shown two views of another vehicle 310. FIG. 5 shows an elevation of a rear portion of the vehicle 310 and FIG. 6 shows an illustrative cross section from the viewpoint of a line 6-6 of FIG. 5.

The rear of the vehicle 310 includes a bumper 312, but similar configurations may be incorporated into deck lids, lift gates, or tail lamp assemblies on the rear of the vehicle 310. A license plate 314 is attached to the bumper 312, and at least one lighting apparatus 318 illuminates the license plate 314. Although the vehicle 310 is illustrative of a pickup truck, other vehicle types may utilize the lighting apparatus 318.

The lighting apparatus 318 includes an appliqué 320 having an exterior surface that faces away from the license plate 314. The exterior surface is substantially opaque and may be covered with, for example, chrome plating or paint.

In the configuration shown, the lighting apparatus 318 is side-mounted, as opposed to the top-mounted configurations shown in FIGS. 1-4. As used herein, especially with regard to the side-mounted applications, the appliqué 320 can include or be formed from portions of the bumper 312 of the vehicle 310. The bumper 312 houses a light source 324 and a light guide 326 that carries light to the license plate 314.

The lighting apparatus 318 may also be side-mounted within a portion of a deck lid, lift gate, or tail lamp assembly adjacent to the license plate 314, as opposed to mounted within the bumper 312, as shown in FIGS. 5-6. Any of the other configurations of lighting apparatus shown in FIGS. 1-4 may also be side-mounted within a bumper, a deck lid, or a lift gate.

The lighting apparatus 318 may also be incorporated within a tail lamp assembly. Furthermore, the light apparatus 318, and also the top-mounted configurations shown in other figures, may be incorporated into lift gates of vehicles (for example, on pickup trucks, sport utility vehicles, or wagons).

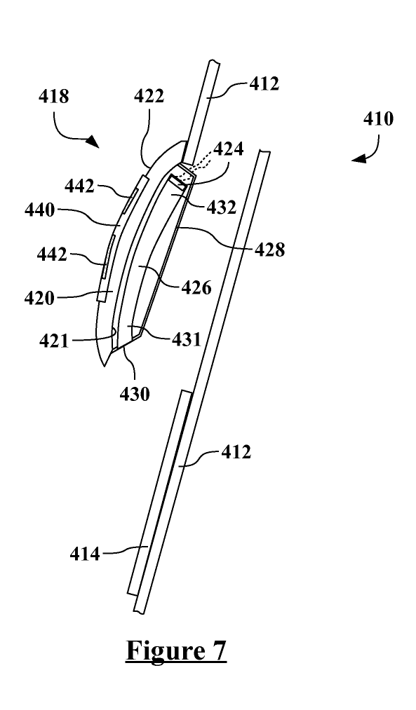

Referring now to FIG. 7, and with continued reference to FIGS. 1-6, there is shown a portion of another vehicle 410 having a deck lid 412 with a license plate 414 attached thereto. A lighting apparatus 418 illuminates the license plate 414. FIG. 7 shows a plane-intersection view taken from the line 7-7 from FIG. 1, which is generally near the center of the vehicle 10. The lighting apparatus 418 shown in FIG. 7 may also be used with the vehicle 10 of FIG. 1 or the vehicle 310 shown in FIG. 5.

The lighting apparatus 418 includes an appliqué 420 having an exterior surface 422 that faces away from the license plate 414 and an interior surface 421 that faces toward the license plate 414. The exterior surface 422 is largely covered with an opaque coating, which may be, without limitation, chrome plating or paint.

A light source 424 acts as the light source for the lighting apparatus 418, and a light guide 426 carries light from the light source 424 and casts it onto the license plate 414. In the configuration shown, a housing plate 428 is disposed between the light guide 426 and the license plate 414. The housing plate 428 may be substantially opaque, translucent, or clear.

A first optic 430 is formed on a first end 431 of the light guide 426. The light guide 426 has a second end 432 substantially opposite the first end 431. In the configuration shown in FIG. 7, the light source 424 abuts, or is embedded within, the second end 432.

In the lighting apparatus 418, the appliqué 420 and the light guide 426 are separate elements, but may be assembled into a single module. Therefore, the lighting assembly 418 may be attached to the deck lid 412 as a single unit or module.

Additionally, the lighting apparatus 418 includes an emblem 440 disposed on the exterior surface 422 of the appliqué 420. The emblem 440 may be, for example and without limitation: a company logo, brand name, or model name of the vehicle 410.

The emblem 440 includes a translucent region 442. Light from the light source 424 illuminates the emblem 440 by backlighting the translucent region 442. In some configurations, the translucent region 442 may be substantially transparent.

The emblem 440 may be formed in the opaque coating of the exterior surface 422 and differentiation of the translucent region 442 may be formed by masking out portions of the emblem. Alternatively, the emblem may be printed, such as through silk-screening or pad printing techniques, onto the appliqué 420, with the translucent regions 442 either left blank or printed with lesser coverage.

The emblem 440 may also be formed as a separate insert. For example, a plastic insert may be used for the emblem 440, with the translucent regions 442 formed from different-colored plastic or from portions of the insert that are not painted. In the configuration shown, the light guide 426 carries much of the light from the light source 424 to the first optic 430 via total internal reflection. However, some of the light escapes the light guide 426 and hits the back of the emblem 440. This results in backlighting of the emblem 440.

When used on the rear of the vehicle 410, the emblem 440 or translucent region 442 may need to have a different color from the light cast onto the license plate 414. For example, the light source 424 may emit white light for illuminating the license plate 414. However, the emblem 440 may be formed from red plastic—or covered in translucent red coating—such that the light emitted through the translucent region 442 toward the rear of the vehicle is red (similar to rear-facing running lights or tail lights).

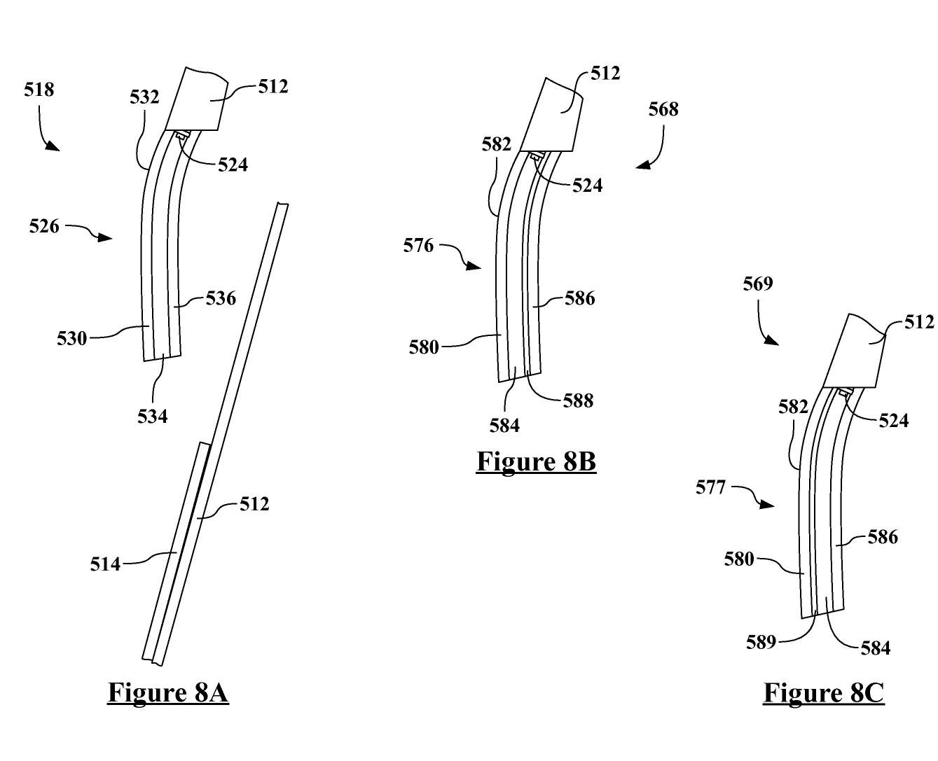

Referring now to FIG. 8A and with continued reference to FIGS. 1-7, there is shown a portion of a vehicle having a deck lid 512 with a license plate 514 attached thereto. A lighting apparatus 518 illuminates the license plate 514. FIG. 8A shows a plane-intersection view taken from a similar viewpoint to the line 2-2 of FIG. 1, and the lighting apparatus 518 may also be used with the vehicle 10 of FIG. 1.

The lighting apparatus 518 includes a light source 524, which acts as the light source for the lighting apparatus 518. A multilayer light guide 526 is configured to carry light from the light source 524 to the license plate 514 in order to illuminate the license plate 514 when desired.

The multilayer light guide 526 is formed from a plurality of layers. A first layer 530 has an exterior surface 532 opposite the license plate 514. In the configuration shown, there is no separate appliqué. However, the first layer 530 of the multilayer light guide 526 may provide the functionality of the appliqué in other embodiments. The multilayer light guide 526 may have an opaque coating substantially covering the exterior surface 532 of the first layer 530. For example, and without limitation, the opaque coating may be chrome plating or paint.

A second layer 534 of the multilayer light guide 526 is disposed between the first layer 530 and the license plate 514. The second layer 534 directly abuts the light source 524, and acts as the primary carrier of light from the light source 524 to the license plate 514.

A third layer 536 of the multilayer light guide 526 is disposed between the second layer 534 and the license plate 514, such that the third layer 536 may be the interior-most member of the multilayer light guide 526. The first layer 530, second layer 534, and third layer 536 may be formed from a first material, second material, and third material, respectively.

In some configurations, each of the first material, second material, and third material may be different materials. However, the second material forming the second layer 534 has a greater index of refraction than at least one of the first material forming the first layer 530 and the third material forming the third layer 536. The third layer 536 shown may be representing a coating, which is applied to the second layer 534 instead of being formed separately.

In the multilayer light guide 526 shown in FIG. 8A, the second material forming the second layer 534 has a greater index of refraction than both the first material forming the first layer 530 and the third material forming the third layer 536. The relative index of refraction between the adjoining layers affects the passing or exchange of light between adjacent layers.

In the multilayer light guide 526, each of the three layers may be formed from one of at least two types of plastic. Note that the first layer 530 and the third layer 536 may be formed from the same material, but not the second layer 534. The materials of the first layer 530, second layer 534, and third layer 536 may be formed separately and then bonded or adhered together. Alternatively, the layers may be molded together, which may allow concurrent forming and bonding of the multilayer light guide 526. The multilayer light guide 526 may be considered to have integrated structure, but is not a one-piece structure.

The multilayer light guide 526 may also be used with an emblem disposed on the exterior surface 532 of the first layer 530. This may be a similar emblem to that shown in FIG. 7. Then the emblem is backlit by light from the light source 524 passing through the first layer 530. As in other configurations, the multilayer light guide 526 may include an interior cover plate between the third layer 536 and the license plate 514.

Optical elements may be included to purposefully redirect some light to the emblem or to otherwise control light flow through the multilayer light guide 526. These optical elements may be incorporated on the surfaces of the layers, between the layers, or inside the layers to direct light.

Referring now to FIG. 8B and FIG. 8C, and with continued reference to FIGS. 1-8A, there are shown two variations of the lighting apparatus 518 shown in FIG. 8A. These variations may be used interchangeably with the lighting apparatus 518 shown in FIG. 8A.

In FIG. 8B, a lighting apparatus 568 includes a light source 524, which acts as the light source for the lighting apparatus 568. A multilayer light guide 576 is configured to carry light from the light source 524 to a license plate, which is not shown but may be located similarly to the license plate 514 shown in FIG. 8A.

The multilayer light guide 576 is formed from a plurality of layers. A first layer 580 has an exterior surface 582, which may be substantially covered by an opaque coating. For example, and without limitation, the opaque coating may be chrome plating or paint. Alternatively, the first layer 580 may be formed from an opaque material.

A second layer 584 of the multilayer light guide 576 is disposed between the first layer 580 and the license plate, and a third layer 586 is disposed between the second layer 584 and the license plate. The first layer 580 and the third layer 586 shown may be representing coatings, which are applied to the second layer 584 instead of being formed separately.

Unlike the multilayer light guide 526, the multilayer light guide 576 also includes an air layer 588 disposed between the second layer 584 and the third layer 586. The air layer 588 may be open to the environment or, more-likely, enclosed within the multilayer light guide 576.

The first layer 580, second layer 584, and third layer 586 may be formed from a first material, second material, and third material, respectively. In the multilayer light guide 576, the second layer 584 has higher index of refraction than the first layer 580. However, the third material forming the third layer 586 is not restricted and may have the same, or even higher, refraction than the second material forming the second layer 584, because the air layer 588 has lower index of refraction than the second layer 584 and provides separation for the third layer 586.

In FIG. 8C, a lighting apparatus 569 includes a light source 524, which acts as the light source for the lighting apparatus 569. A multilayer light guide 577 is configured to carry light from the light source 524 to a license plate, which is not shown but may be located similarly to the license plate 514 shown in FIG. 8A.

The multilayer light guide 577 is formed from a plurality of layers. A first layer 580 has an exterior surface 582, which may be substantially covered by an opaque coating. For example, and without limitation, the opaque coating may be chrome plating or paint. Alternatively, the first layer 580 may be formed from an opaque material, without the coating.

A second layer 584 of the multilayer light guide 577 is disposed between the first layer 580 and the license plate, and a third layer 586 is disposed between the second layer 584 and the license plate.

The multilayer light guide 577 also includes an air layer 589 disposed between the second layer 584 and the first layer 580. The air layer 589 may be open to the environment or, more-likely, enclosed within the multilayer light guide 577.

In the multilayer light guide 577, the second layer 584 has higher index of refraction than the third layer 586, which directly contacts the second layer 584. However, the first material forming the first layer 580 is not restricted and may be the same as the second material forming the second layer 584, or may be formed from a material having either lower or higher index of refraction. In either the multilayer light guide 576 or the multilayer light guide 577, the layers adjacent to, and contacting, the second layer 584 are formed from materials having a lower refraction index than the second layer 584, including the air layer 588 and the air layer 589.

Optical elements may be included to purposefully redirect some light to the emblem or to otherwise control light flow through the multilayer light guide 576 or the multilayer light guide 577. These optical elements may be incorporated on the surfaces of the layers, between the layers, or inside the layers to direct light.

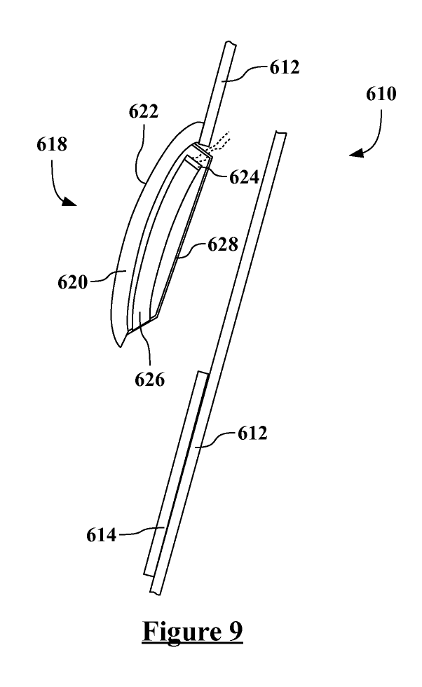

Referring now to FIG. 9, and with continued reference to FIGS. 1-8C, there is shown a portion of another vehicle 610 having a deck lid 612 with a license plate 614 attached thereto. A lighting apparatus 618 illuminates the license plate 614. FIG. 9 also shows a plane-intersection view taken from a similar viewpoint to the line 2-2 from FIG. 1, and the lighting apparatus 618 shown may also be used with the vehicle 10 of FIG. 1.

The lighting apparatus 618 includes an appliqué 620 having an exterior surface 622 that faces away from the license plate 614. The exterior surface 622 is substantially covered with an opaque coating, which may be, without limitation, chrome plating or paint. Alternatively, the appliqué 620 may be formed from an opaque material, without the coating.

A light source 624 acts as the light source for the lighting apparatus 618, and a multilayer light guide 626 carries light from the light source 624 and casts it onto the license plate 614. In the configuration shown, a housing plate 628 is disposed between the multilayer light guide 626 and the license plate 614. The housing plate 628 may be substantially opaque, translucent, clear, or transparent.

The multilayer light guide 626 is formed from a multilayer optical film. In the multilayer light guide 626 shown in FIG. 9, the layers of the multilayer optical film are oriented substantially perpendicular to the light source 624, such that light from the light source 624 passes through a plurality of the layers on its way to the license plate 614.

Optical elements may be included to purposefully redirect some light to the emblem or to otherwise control light flow through the multilayer light guide 626. These optical elements may be incorporated on the surfaces of the layers, between the layers, or inside the layers to direct light.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A lighting apparatus for illuminating a license plate, comprising:
a light source; and
a multilayer light guide configured to carry light from the light source and to cast light onto the location of the license plate, wherein the multilayer light guide includes:
a first layer having an exterior surface opposite the location of the license plate;
a second layer disposed between the first layer and the location of the license plate and directly abutting the light source; and
a third layer disposed between the second layer and the location of the license plate,
wherein the second layer has greater index of refraction than at least one of the first layer and the third layer.

2. The lighting apparatus of claim 1, further comprising:
an air layer disposed between the second layer and one of the first layer and the third layer, wherein the second layer has higher index of refraction than the other of the first layer and the third layer.

3. The lighting apparatus of claim 2, further comprising:
an opaque coating substantially covering the exterior surface of the first layer;

4. The lighting apparatus of claim 3, further comprising:
an emblem disposed on the exterior surface of the first layer, wherein the emblem is backlit by light from the light source passing through the first layer.

5. The lighting apparatus of claim 4, wherein the opaque coating is one of chrome plating and paint.

6. The lighting apparatus of claim 5, wherein the light source includes one or more LED lights distributed across the multilayer light guide.

7. The lighting apparatus of claim 1, wherein the second layer has a greater index of refraction than both the first layer and the third layer.

8. The lighting apparatus of claim 1, further comprising:
an air layer disposed between the first layer and the second layer, wherein the second layer has higher index of refraction than the third layer.

9. The lighting apparatus of claim 1, further comprising:
an air layer disposed between the third layer and the second layer, wherein the second layer has higher index of refraction than the first layer.

10. A lighting apparatus for illuminating a license plate, comprising:
a light source;
an appliqué formed from a first material and having an exterior surface facing away from the location of the license plate; and
a light guide between the appliqué and the location of the license plate, and having a first end proximal to the location of the license plate and a second end proximal to the light source, such that the light guide carries light from the light source toward the location of the license plate, wherein the light guide is formed from a multilayer optical film.

11. The lighting apparatus of claim 10, wherein layers of the multilayer optical film are oriented substantially perpendicular to a mounting plane of the light source.

12. The lighting apparatus of claim 11, wherein the exterior surface is substantially covered with an opaque coating.

13. The lighting apparatus of claim 12, further comprising:
an emblem disposed on the exterior surface of the appliqué, wherein the emblem is backlit by light from the light source.

14. The lighting apparatus of claim 13, wherein the light source is formed from at least one LED element.

15. The lighting apparatus of claim 13, wherein the light source includes a plurality of LED lights distributed across the multilayer light guide.
